(19) United States
(12) Patent Application Publication
(10) Pub. No.: US 2003/0174784 A1
(43) Pub. Date: Sep. 18, 2003

(54) Method and system for digital modulation for burst mode applications

(76) Inventors: Vajira N. S. Samarasooriya, Nepean (CA); Eric Johnson, Nepean (CA); Robert Wood, Gloucester (CA); Din Lee, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/327,931

(22) Filed: Dec. 26, 2002

Related U.S. Application Data
(60) Provisional application No. 60/342,124, filed on Dec. 26, 2001.

(51) Int. Cl. H04L 27/20

(52) U.S. Cl. 375/308

(57) ABSTRACT

A method and system for digital modulation, particularly in burst mode applications, using a root raised cosine filter operating at a rate of four-samples-per-symbol. The raised cosine pulse-shaped baseband signal is interpolated in order to achieve a sampling rate of 44.96 MHz at the digital up-converter. The two-stage interpolation provides an overall interpolation ratio of 20. The digital upconverter performs the frequency adjustments for channelization and Doppler correction.

This application claims the benefit of priority from U.S. Provisional Application No. 60/342,124 filed on Dec. 26, 2001.

### FIELD OF THE INVENTION

The present invention relates generally to digital modulators. More particularly, the present invention relates to a method and system for digital modulation for burst mode applications, particularly in a satellite-based wireless communication system.

### BACKGROUND OF THE INVENTION

Wireless communication systems are used for many different types of data transmission in order to provide a variety of services. Some services require data to be transmitted in a continuous stream, or mode, whereas other services can manage well when data is sent in non-continuous bursts of data. In a burst mode of data transmission, information typically flows in short intense data groupings (often packets or frames) with relatively long silent periods between each transmission burst. These bursts can follow a predefined burst pattern with respect to the data source. For instance, a superframe can contain four frames, with one or more of the frames (or portions thereof) containing data. A frame burst pattern is defined by which frames within a predefined window of observation, such as a superframe, contain data. A service provider may allow a particular customer to transmit data in certain frames or portions thereof, and parameters such as expected service reliability and guaranteed bandwidth can be defined in service level agreements for each customer.

For a satellite-based modem design, the uplink frequency of the a modulator requires digital adjustment within the transmit band in discrete steps of 2.5 kHz up to 58.5 kHz. The uplink frequency also requires adjustment to compensate for Doppler shifts due to the movement of the satellite with respect to the terminal. The transmitted signal must meet the adjacent channel emission specifications, and must achieve a burst timing accuracy of better than 10% of a symbol period to ensure correct demodulation of transmitted data at the payload.

A typical digital modulator architecture consists of a root raised cosine filter, interpolation stages and a digital up-converter. The modulator architecture must be capable of operating at 562 ksps and 2.81 Msps in burst mode. A conventional architecture for root raised cosine filtering and interpolation involves FIR filter stages that are implemented in either canonical or transposed form. The hardware requirements for this can be high depending on the length of the FIR stages. This often results in hardware designs with high gate counts.

It is, therefore, desirable to provide an all digital modulator for burst mode communications.

### SUMMARY OF THE INVENTION

It is an object of the present invention to obviate or mitigate at least one disadvantage of previous digital modulators.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates an exemplary digital modulator architecture of the present invention;

FIG. 2 illustrates frequency translation in the digital domain according to an embodiment of the present invention;

FIG. 3 illustrates a frequency up converter in the analog domain according to the present invention;

FIG. 4 illustrates a numerically controlled oscillator of the present invention;

FIG. 5 illustrates the theoretical raised cosine filter output spectrum for α equals 0.25;

FIG. 6 illustrates the spacing of adjacent channels in an exemplary embodiment of the present invention;

FIG. 7 illustrates sampling rates at the RC filter;

FIG. 8 illustrates sampling rates at the interpolation stage for an exemplary embodiment of the present invention;

FIG. 9 illustrates the effect of a finite window length on the RC filter output spectrum;

FIG. 10 illustrates RC filter output spectrum at four samples per symbol;

FIG. 11 illustrates the frequency spectrum at the input and output of the L5 filter;

FIG. 12 illustrates the frequency spectrum at the input and output of the L4 filter;

FIG. 13 illustrates the spectrum of the L5 filter input using 15 bit taps and 15 bit internal arithmetic;

FIG. 14 illustrates the spectrum of the L4 filter input using 15 bit taps and 15 bit internal arithmetic;

FIG. 15 illustrates the spectrum of the 10 bit DAC output;

FIG. 16 illustrates the curve represented by I*cos(wt) for w equals 58.5 kHz;

FIG. 17 illustrates the curve represented by I*cos(wt) plus Q*sin(wt) for w equals 58.5 kHz;

FIG. 18 illustrates the curve represented by I*cos(wt) for w equals 2 MHz;

FIG. 19 illustrates the curve represented by I*cos(wt) plus Q*sin(wt) for w equals 2 MHz;

FIG. 20 illustrates a functional diagram of a system of the of the present invention;

FIG. 21 illustrates an interpolation filter for increasing sample rate by a factor of four;

FIG. 22 illustrates an FIR filter interpolated by a factor of four in canonical form;

FIG. 23 illustrates an FIR filter interpolated by a factor of four in simplified canonical form;

FIG. 24 illustrates the timing interface of rcinterp4 at classB;

FIG. 25 illustrates an exemplary embodiment of the architecture of FIG. 4;

FIG. 26 illustrates the interface timing of interp5 at classA;

FIG. 27 illustrates the block diagram of interp5 with 25 taps;

FIG. 28 illustrates the interface timing of interp4 module;

FIG. 29 illustrates the timing diagram for an up converter module of the present invention;

FIG. 30 illustrates sine wave generation according to an embodiment of the present invention; and

FIG. 31 illustrates the timing of the top system module.

### DETAILED DESCRIPTION

Generally, the present invention provides a method and system for digital modulation, particularly in burst mode applications, using a root raised cosine filter operating at a rate of four-samples-per-symbol. The raised cosine pulse-shaped baseband signal is interpolated in order to achieve a sampling rate of 44.96 MHz at the digital up-converter. The two-stage interpolation provides an overall interpolation ratio of 20. The digital upconverter performs the frequency adjustments for channelization and Doppler correction.

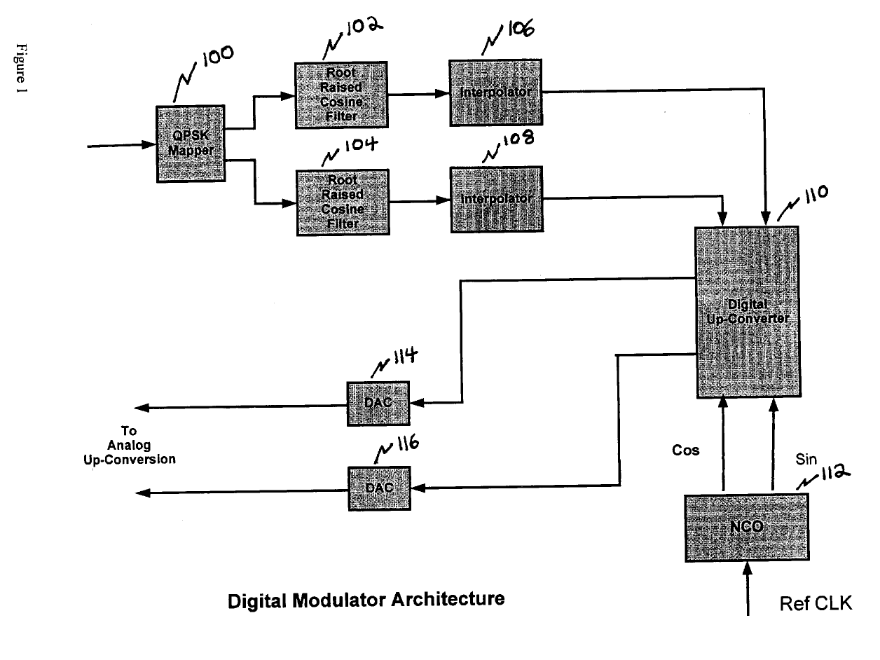

The modulator of the present invention, as illustrated in FIG. 1, receives the output of a digitizer, such as an analog to digital converter that samples an incoming analog signal received from an air interface. The digitized signal is provided to a QPSK mapper 100. QPSK 100 provides a pair of outputs, corresponding to the I and Q data streams, to filters 102 and 104 respectively. In a presently preferred embodiment, the filters are root raised cosine filters selected to filter the incoming signal to meet frequency bandwidth requirements. The filtered signals are provided to interpolators 106 and 108, which then provides digital signals to a digital up-converter 110. Digital up-converter 110 also has as input sine and cosine signals provided by numerically controlled oscillator (NCO) 112. The upconversion of the interpolated signals converts the digital data into 1K˜58 kHz. The up-converted data is then converted to an analog signal using DAC 114 and DAC 116. The output of DAC 114 and 116 is then provided to an analog up-conversion system.

The current modulator preferably supports two types of channels, class A and class B, which transmit at 0.562 and 2.81 Msps respectively. The modulator is preferably driven by a sample clock operating at 44.96 MHz, which is a multiplier of 80 for the lower data transfer rate, and a multiple of 16 for the higher data transfer rate. As a result, class A channel data is interpolated by a factor of 80, while class B channel data is interpolated by a factor of 16, so that the system sample frequency is met.

The QPSK symbol stream is pulse-shaped for transmission using a root raised cosine filter with an excess bandwidth factor of 0.25. Following root raised cosine filtering, the I and Q channel signals are interpolated to increase the sampling rate. The interpolated I and Q channel symbol streams are then frequency translated by ^{ω}^{₁}, where ω₁=2.5-58.5 kHz. A Numerically Controlled Oscillator (NCO) is employed to generate the in-phase and quadrature components of the translation frequency ^{ω}^{₁}.

The in-phase and quadrature components from the digital modulator are sent to the DACs 114 and 116. The analog frequency up-conversion handles the frequency hopping requirements. The modulator uses symbol rates of 0.562 Msps and 2.81 Msps for Class A and B channels respectively as shown in Table 1. The modulator design preferably supports both class A and class B symbol rates.

TABLE 1
Up-link symbol rates

| | Channel Class | | |
|---|---|---|---|
| Descriptions | A | B | C |
| Modulation | QPSK | QPSK | QPSK |
| Symbol Rate (Msps) | 0.562 | 2.81 | 14.05 |
| RF Bandwidth per Symbol Rate Ratio | 1.25 | 1.25 | 1.25 |
| Number of Channels in 125 MHz | 175 | 35 | 7 |
| Channel RF Bandwidth (MHz) | 0.7025 | 3.5125 | 17.5625 |

The terminal modulator is required to achieve frequency hopping over the specified frequency range. The frequency hopping over 125 MHz is implemented in the IF modulator by switching between the frequency synthesizers that control the VCO generating the final uplink frequency.

In addition, the uplink frequency is required to be adjusted within the transmit band in discrete steps of 2.5 kHz up to 58.5 kHz. This requirement arises from the fact that the channel bandwidth is 125 MHz and the Class A and Class B channel spacing is a multiple of 702.5 kHz. In a given 125 MHz bandwidth there can be a combination of Class A, B, and C channels. Since 125 MHz is not an integer multiple of 702.5 kHz, the center frequency of a particular channel can be adjusted by 2.5-58.5 kHz as needed.

The uplink frequency is also adjusted to compensate for Doppler shifts due to the movement of the satellite with respect to the terminal. A frequency adjustment in the range 2.5 kHz up to 58.5 kHz is achieved efficiently in the digital domain using a quadrature digital up-converter.

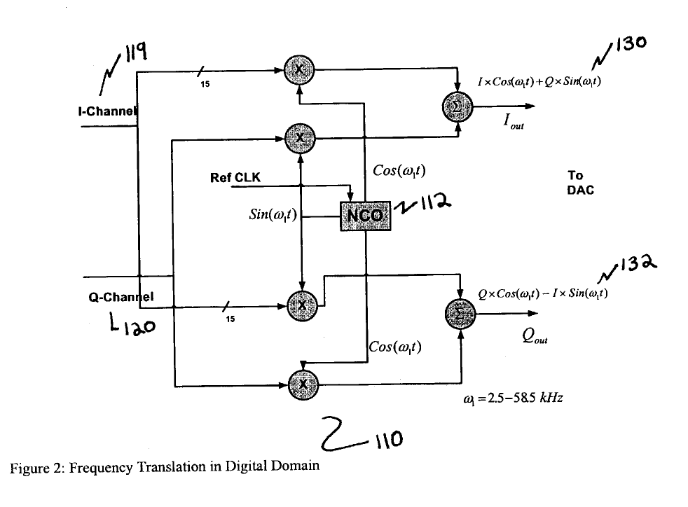

FIG. 2 illustrates a digital quadrature up-conversion system. I channel signal 118 from interpolator 106, and Q channel signal 120 from interpolator 108 are provided to a series of multipliers and adders. Each of the I signal 118 and the Q signal 120 are provided to two multipliers. Each signal is multiplied by sin (? ₁t) in its first multiplier and by cos(? ₁t) in its second multiplier. The sine and cosine signals are provided by NCO 112 which is driven by a reference clock signal. The results of the multiplications are fed to one of two adders, so that the output signals 130 and 132 are provided as:

Iₒᵤₜ=I×Cos(ω₁t)+Q×Sin(ω₁t)

Qₒᵤₜ=Q×Cos(ω₁t)−I×Sin(ω₁t)

Where, ω₁=2.5-58.5 kHz.

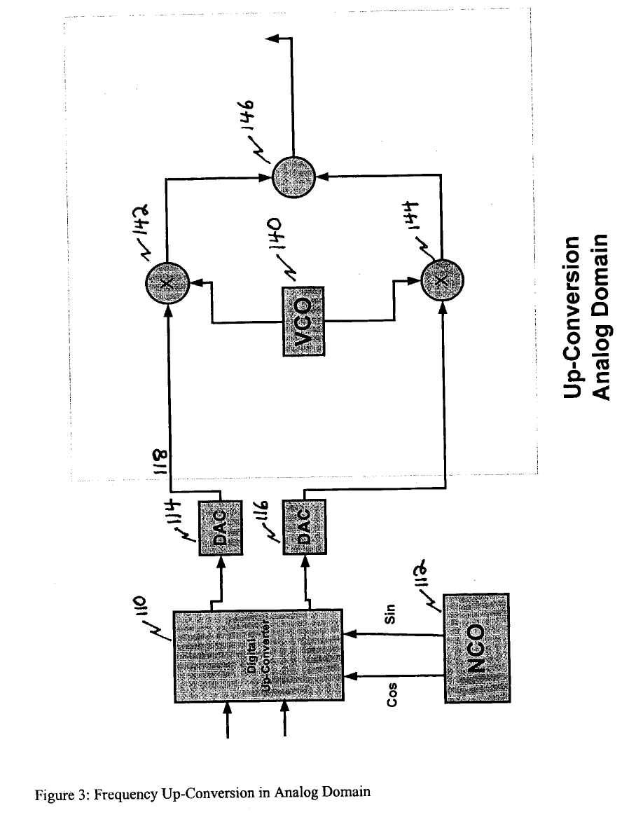

The signals ^{I}^{ₒᵤₜ}, and ^{Q}^{ₒᵤₜ} are in phase quadrature. The digitally frequency translated signals ^{I}^{ₒᵤₜ}, and ^{Q}^{ₒᵤₜ} are up-converted in the analog domain as shown in FIG. 3. Digitally up-converted signals 130 and 132 are provided to DAC 114 and DAC 116 respectively. The resulting analog signals are signals 118 and 120 respectively. Signal 118 is provided to multiplier 140, while signal 120 is provided to multiplier 144. The second input to each of multiplier 142 and 144 is the output of a voltage controlled oscillator (VCO) 140. The outputs of multipliers 142 and 144 are provided to operator 146. In a presently preferred embodiment, operator 146 is an adder so that the output is the sum of the outputs of multipliers 142 and 144, though one skilled in the art will appreciate that operator 146 can also alternately be another logical operator, such as a multiplier or a subtractor.

The following is a heuristic proof of the digital frequency translation scheme. Denoting the frequency of a single tone signal input as ^{ω}^{ₘ}, we write the I and Q channel inputs as,

I=Cos(ωₘt),

Q=Sin(ωₘt).

Therefore, the signals ^{I}^{ₒᵤₜ}, and ^{Q}^{ₒᵤₜ} can be written as follows.

$$\begin{matrix}{I}_{out} = Cos ( {ω}_{m} t ) \times Cos ( {ω}_{1} t ) + Sin ( {ω}_{m} t ) \times Sin ( {ω}_{1} t ) \\ = Cos ( ( {ω}_{1} - {ω}_{m} ) t )\end{matrix}$$

$$\begin{matrix}{Q}_{out} = Sin ( {ω}_{m} t ) \times Cos ( {ω}_{1} t ) - Cos ( {ω}_{m} t ) \times Sin ( {ω}_{1} t ) \\ = Sin ( ( {ω}_{m} - {ω}_{1} ) t )\end{matrix}$$

Therefore, the signals ^{I}^{ₒᵤₜ}, and ^{Q}^{ₒᵤₜ} are in phase quadrature.

A look-up table based numerically controlled oscillator (NCO) is preferably used to generate a frequency and phase tunable output signal that is used to frequency translate the baseband I and Q signals by the specified 2.5-58.5 kHz. The NCO is provided with a precision reference clock that is derived from the AT local oscillator and synchronized using demodulator timing recovery.

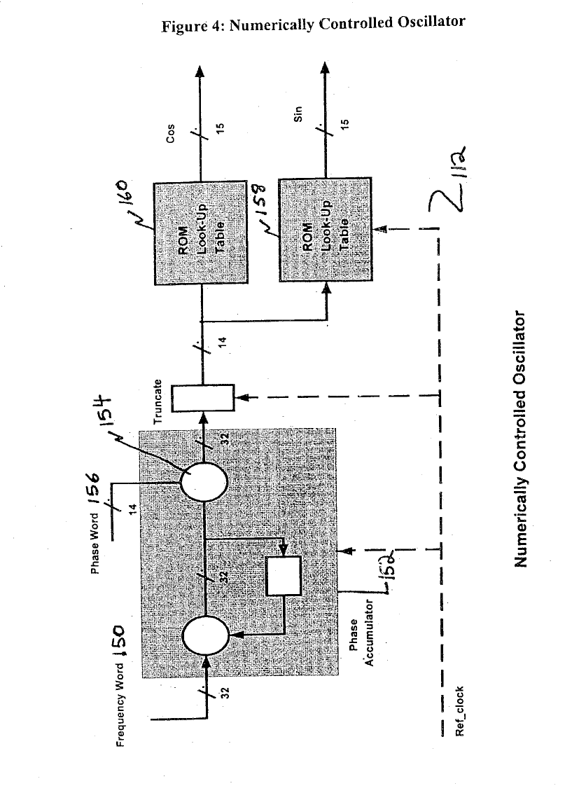

FIG. 4 illustrates the architecture of NCO 112 according to an embodiment of the present invention. The reference clock frequency is divided in NCO 112 by means of a programmable frequency tuning word 150. Tuning word 150 is typically 24-48 bits long, which results in excellent frequency tuning resolution. Preferably NCO 112 employs a 32 bit phase accumulator 152.

The output frequency of the NCO 112 is determined by the formula:

$${f}_{out} = \frac{M \times ref\_clock}{{2}^{N}}$$

Where:

fₒᵤₜ=output frequency of the NCO

M=Frequency tuning word

ref_clock=reference clock

N=The length in bits of the phase accumulator

The inclusion of adder 154 after phase accumulator 152 enables the output sine wave to be phase delayed according to a programmable phase control word 156. A phase control word length of 14 bits is presently preferred.

The K-bit LUT address is formed by truncating the N-K least significant bits of the phase accumulator output. This results in sine ROM 158 and cosine ROM 160 of size 2_{K}. Truncation of the phase accumulator results in introducing discrete frequency spurs at the NCO output. K=14 (look-up table size of 256×16×12) is preferably used. The distortion introduced to the NCO output due to the truncation of the phase accumulator depends on three design parameters. Namely, the phase accumulator word-size, the number of bits after truncation ( LUT address size), and the frequency word at the input. The phase truncation spurs resulting from the truncation of the 32-bit phase accumulator word to K-bits will have a magnitude of 6.02K dBc in the worst case. For K=14 the worst case spurs will have a magnitude upper bound of 84 dBc.

It is possible to adjust the uplink frequency in the digital modulator by frequencies larger than the specified 2.5-58.5 kHz. The NCO clock is high enough to accommodate the generation of a wider range of frequencies out of the NCO 112 if needed. The terminal achieves timing and synchronization by using data derived from the downlink channel. Downlink timing recovery generates a reference clock frequency that is synchronized to the payload clock with the specified accuracy In addition downlink timing recovery also performs frame synchronization. The extracted downlink reference clock and the frame synchronization information is used to generate all uplink burst times and frequencies.

As shown in FIG. 2, the digital modulator NCO 112 is provided with a reference clock that is derived from the local reference DDS and synchronized using demodulator timing recovery.

The design of the root raised cosine filter and the subsequent interpolation stage is now discussed. The adjacent channel emission specification at the output of DAC 116 and 114 can be represented as a function of the length of raised cosine (RC) filters 102 and 104, the characteristics of interpolators 106 and 108, and the resolution of DAC 116 and 114. Some of the key design parameters are the adjacent channel separation and the adjacent channel emission specification.

In the following sections, the adjacent channel rejection specification is discussed, and a configuration of the root raised cosine filters 102 and 104, and their respective interpolators 106 and 108 is described. Simulation results using both fixed and floating point evaluations are also described.

The I- and Q-channels of the uplink QPSK symbol stream are individually pulse shaped as follows:

$${x}_{I} ( t ) = {\sum }_{k} [ 2 {I}_{k} - 1 ] p ( t - {kT}_{symbol} )$$

$${x}_{Q} ( t ) = {\sum }_{k} [ 2 {Q}_{k} - 1 ] p ( t - {kT}_{symbol} )$$

where^{p(t)} is a Square-Root Raised Cosine (SRRC) pulse shape with ^{α=0.25},^{T}^{_{symbol}} is the uplink symbol period, the inverse of the symbol rate and Ik and Qk are binary sequences ^{∈{0,1}}. The pulse shape ^{p(t)} is:

$$p ( t ) = \frac{1}{2 π} {\int }_{- ∞}^{∞} P ( f ) {ⅇ}^{- j 2 π f t} ⅆ f$$

where

$$P ( f ) = \{ \begin{matrix}1 , & \vert f \vert \leq \frac{1 - α}{2 {T}_{symbol}} , \\ \sqrt{\frac{1}{2} \{ 1 - sin [ \frac{{T}_{symbol} π}{α} ( \vert f \vert - \frac{1}{2 {T}_{symbol}} ) ] \}} , & \frac{1 - α}{2 {T}_{symbol}} < \vert f \vert \leq \frac{1 + α}{2 {T}_{symbol}} , \\ 0 , & \vert f \vert > \frac{1 + α}{2 {T}_{symbol}} .\end{matrix}$$

The modulator employs root raised cosine pulse shaping with a roll-off factor of 0.25.

For the Class A type symbol rate of 0.562 Msps, the first spectral null of the RC filter output appears at 351.25 kHz. Class A Symbol rate=562 ksps

$$\begin{matrix}{f}_{Null} = ( \frac{1 + α}{2} ) \times {f}_{sym} \\ = 0.625 \times {f}_{sym}\end{matrix}$$

For the specified “A” subchannel separation of 702.5 kHz, the lower band edges of the neighboring “A” subchannels begin at approximately ±351.25 kHz.

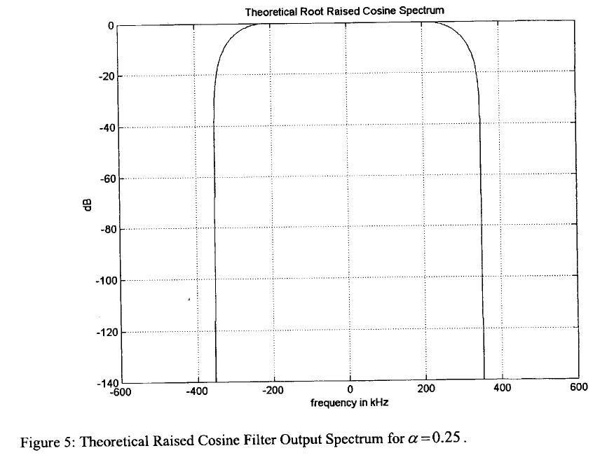

FIG. 5 shows the theoretical root raised cosine filter response for the ‘A’ subchannel. This requirement is derived from the maximum EIRP emissions specification from an terminal (AT) transmitting an ‘A’ or ‘B’ subchannel' into a neighboring 702.5 kHz ‘A’ subchannel. The adjacent channel energy is a result of the following three effects: quantization effects and finite tap-length effects of the root raised cosine filter and interpolating filters, and the quantization loss at the DAC; single sideband rejection of the IF stage; and spectral re-growth at the ODU. The adjacent channel energy in a given channel is the sum of the energy contributed by the above three factors.

The current specification requires the emissions into the adjacent channels to be as follows:

| Trans- | | | |
|---|---|---|---|
| mitting | Emission in | Emission in | Emission in |
| Channel | Adjacent channel 1 | Adjacent channel 2 | Adjacent channel 3 |
| A | 32.8 dBc | 50.3 dBc | 54 dBc |
| B | 30.5 dBc | 33.5 dBc | 54 dBc |

The adjacent channel energy is calculated by integrating the power spectral density of the transmit signal spectrum over the adjacent channel bandwidth. The ratio of the adjacent channel energy to the energy in the signal bandwidth gives the adjacent channel rejection. The spanning in a given adjacent channel can be measured in two ways: assuming a rectangular filter spanning the adjacent channel bandwidth; or assuming a root raised cosine filter over the adjacent channel bandwidth.

The simulation results provided assume a rectangular window over the channel bandwidth. For a given center frequency ^{f}^{₀} of an “A” Subchannel, the ‘A’ subchannels are located at center frequencies ^{f}^{₀}^{±N×702.5 kHz},^{N=±1,±2, . . .} . For a given center frequency ^{f}^{₀} of a “B” Subchannel, the adjacent ‘A’ subchannels are located at center frequencies ^{f}^{₀}^{±N×702.5 kHz}, ^{N=±3,±4, . . .} .

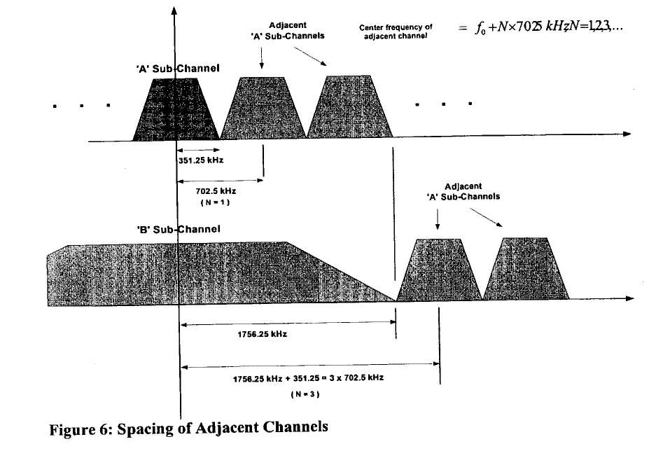

FIG. 6 illustrates the location of adjacent channels when the AT is transmitting on an ‘A’ subchannel and when transmitting on a ‘B’ subchannel. The adjacent ‘A’ subchannel (for N=1) for an ‘A’ subchannel begins at 351.25 kHz. (Theoretical band-edge edge of a 562 ksps ‘A’ subchannel is at 351.25 kHz for the specified excess bandwidth factor

Following root raised cosine pulse shaping, the I and Q channel baseband signal is frequency translated by as much as 58.5 kHz in the digital up-converter. Table 2 below provides the selection of over-sampling rates at the RC filter, interpolator and the digital up-converter.

TABLE 2
Data sampling rates in the digital modulator

| | | | Over- | | | |
|---|---|---|---|---|---|---|
| | | | Sampling | | | |
| | | | Rate | | | |
| | | | at the Digital | | NCO Frequency Tuning | |
| | | | Up- | | Resolution | |
| Symbol | RC Filter | | Converter | NCO | 1.1 For a N-bit Phase | |
| Rate | Over- | Interpolation | (samples- | Clock | Accumulator | |
| Msps | Sampling | Factor L | per-symbol) | Frequency | N = 24 | N = 32 |
| 0.562 | 4 | 5 × 4 | 80 | 44.96 MHz | 2.6798 Hz | ˜0.010468 Hz |
| 2.81 | 4 | 4 | 16 | 44.96 MHz | 2.6798 Hz | ˜0.010468 Hz |

The data sampling rate at the DAC is designed to be the same for Class ‘A’ and ‘B’ type channels. The NCO clock frequency is shown as equal to the data sampling rate at the digital up-converter. The data sampling rate at the DAC also determines the highest clock rate available at the digital modulator for uplink burst timing. The uplink burst timing accuracy is specified to be within 10% of the symbol period. The selection of 44.96 MHz as the DAC input clock enable the modulator to achieve a burst timing accuracy of 6.25% of the symbol period for Class B, and 1.25% of the symbol period for Class A. The sub-Hz NCO frequency tuning accuracy achieved by the current 32-bit accumulator provides very accurate frequency adjustments. The Doppler shift, expected to be less than 200 Hz, can be accurately corrected at the digital up-converter.

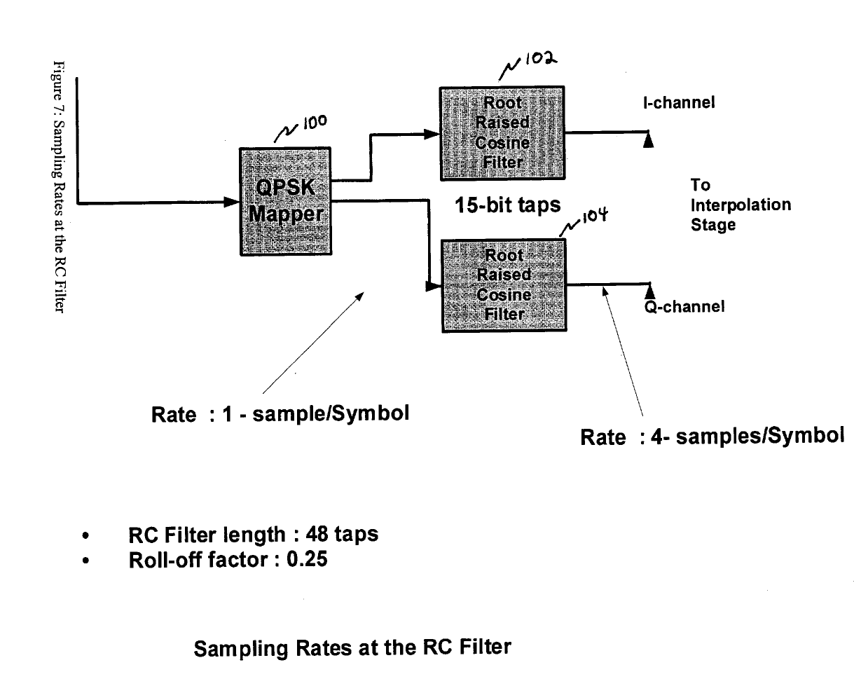

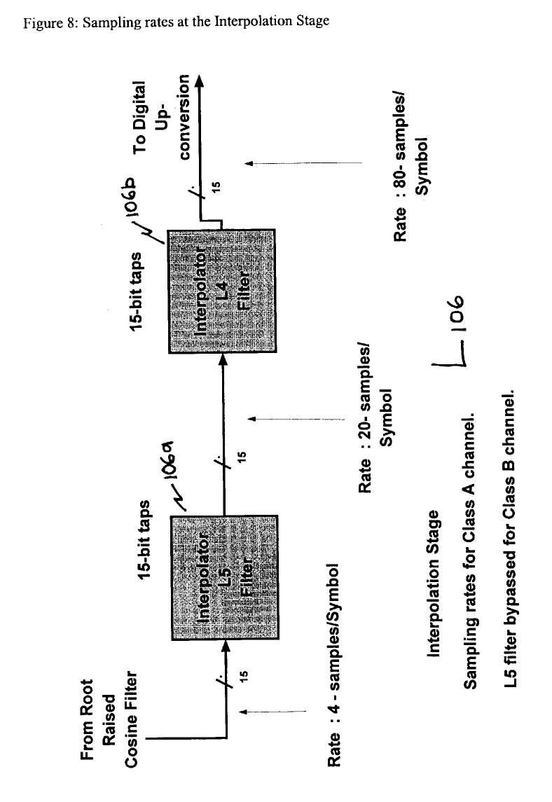

FIG. 7 illustrates the sampling rates at the raised cosine filter. QPSK mapper 100 provides its outputs to root raised cosine filters 102 and 104 which have 15 bit taps. Filter 102 provides the I-channel to interpolator 106, while filter 104 provides the Q-channel to interpolator 108. The total RC filter length is 48 taps, with a roll-off factor of 0.25. FIG. 8 illustrates an interpolator design of the present invention. The result from the RC filter handling the class A channel is received as a 4 sample/symbol signal by the L5 interpolation filter 106a, and is then provided to the L4 interpolation filter 106b as a 20 sample/symbol signal. The class B channel bypasses the L5 interpolation filter. The L4 filter 106b increases the samples/symbol by a factor of 4. The output of L4 106b is provided to the digital up-conversion.

FIG. 1 illustrates the digital modulator architecture. In the current design of the modulator, the root raised cosine filter operates at an over-sampling rate of 4-samples-per-symbol. The root raised cosine filtered I and Q channel signals are interpolated to increase the data sampling rate. The signal is frequency translated by up to 58.5 kHz in the digital up-converter. The up-converted signal is sent to the DAC.

Designing the finite length root raised cosine filter involves using truncating the non-causal infinite-length theoretical impulse response of the root raised cosine filter. The truncation using a finite length window causes the introduction of frequency distortion into the resulting raised cosine spectrum. Windowing introduces sidelobes into the RC filter spectrum. Windowing also causes a smearing effect on the main lobe (the main lobe gets widened as a result of windowing). The width of the main lobe decreases with increasing length of the window. Various windowing techniques including Rectangular, Hamming, Hanning, Bartlett, are used to achieve the desired level of sidelobe attenuation and the main lobe width. The rectangular window results in the narrowest main lobe for a given length of the window (the window length is equal to the number of taps of the RC filter at the selected over-sampling factor). However, the rectangular window also results in the lowest sidelobe rejection among the window types. All other window types result in superior sidelobe rejection compared to the rectangular window. However, this is achieved at the expense of a wider main lobe.

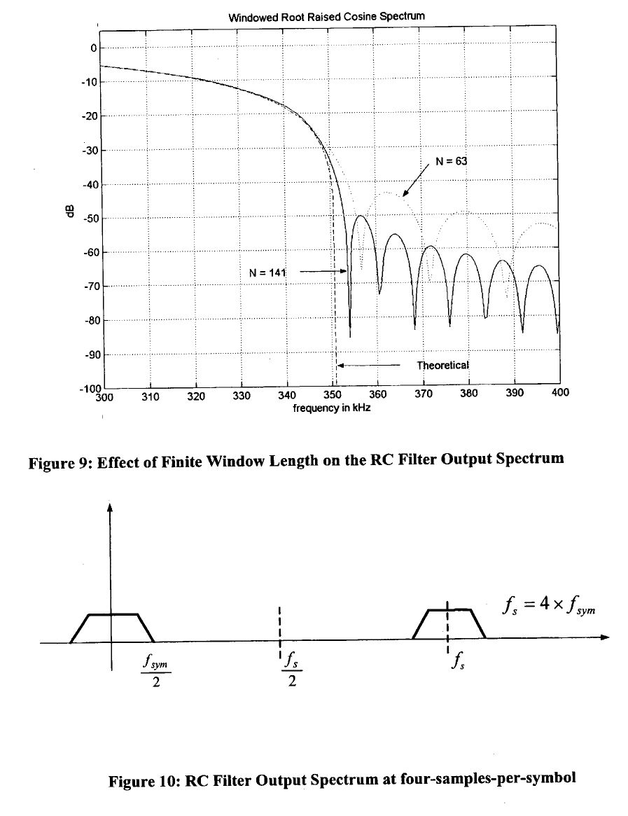

FIG. 9 illustrates the effect of window length on the root raised cosine spectrum for the rectangular window. As shown in FIG. 9, the main lobe is widened by the filter, and as a result the first spectral null for an A subchannel extends beyond the theoretical 354.25 kHz frequency point. The adjacent channel emission specification plays a major role in designing the length of the raised cosine filter 102 or 104, the interpolators 106 or 108, and the resolution of DAC 114 or 116.

The specification for adjacent channel emission does not translate directly to root raised cosine filter spectral mask specification. The length of the filter however, has an effect on the integrated adjacent channel energy.

The following analysis demonstrates the adjacent channel emissions specification by the proper selection of the root raised cosine filter length, and the subsequent interpolating filter characteristics. The presently preferred implementation of the RC filter utilizes the fact that the possible signal input values to the filter consist of +1, −1, and 0. Any given multiplier output in the RC filter (corresponding to tap value ^{h}^{ₙ}) can only assume the values zero, ^{h}^{ₙ}, and ^{-h}^{ₙ}. This enables substitution of the multiplication operation with a MUX that that outputs one of the above values depending on the signal input. Therefore, it is possible to design a raised cosine filter structure without using any multipliers. This amounts to a significant reduction in hardware complexity while making it possible to implement an FIR filter with a large number of taps. A more detailed description of this structure is given in the Hardware description document of the digital modulator. FIG. 7 shows the data sampling rates at the input and the output of the RC filter.

Since the RC filter is run at the rate of four-samples-per-symbol, Class B channel RC filter output is interpolated by a factor of 4 to generate a data sampling rate of 44.96 MHz at the digital up-converter and the DAC. In order to maintain the same data sampling rate of 44.96 MHz at the digital up-converter and the DAC, the Class A RC filter output needs to be interpolated by a factor of 20. Therefore, the baseline architecture shown in FIG. 1 employs an RC filter running at four-samples per symbol and an interpolation stage that interpolates by a factor of 4 for Class B and a factor of 20 for Class A. The interpolation is carried out by means of two interpolation stages in cascade.

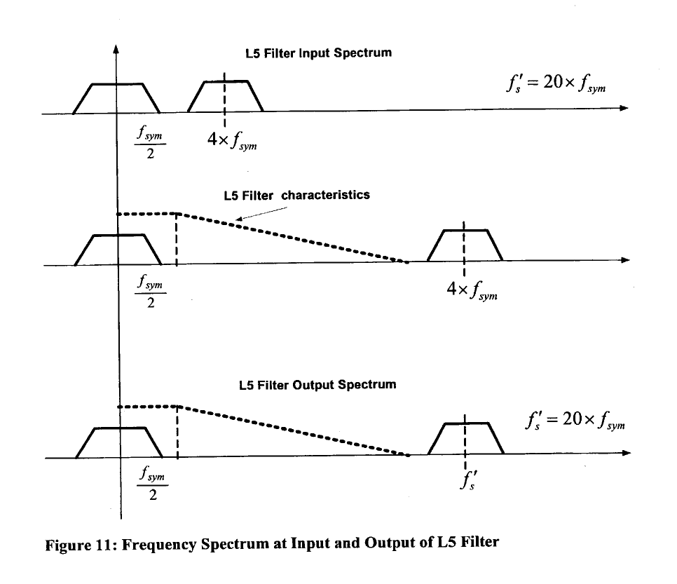

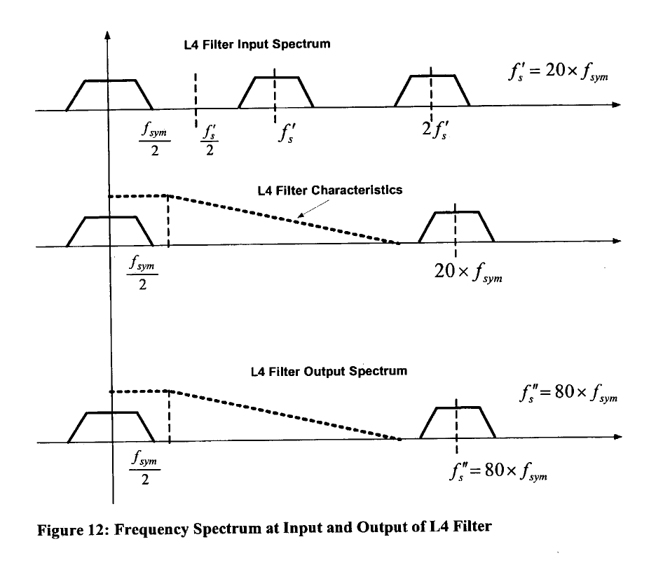

The L5 filter 106A is an equi-ripple symmetric low-pass FIR filter with 25 taps. The L5 filter 106A will be bypassed for the Class B channel. The L4 interpolating filter 106B is a equi-ripple symmetric low-pass FIR filter with 16 taps. FIG. 10, FIG. 11 and FIG. 12 show the frequency spectrum at the output of the RC filter, L5 filter 106A and the L4 filter 106B respectively. The interpolating filters are designed such that the passband spectral characteristics of the RC filter output is preserved. The primary function of the interpolating filters is to remove the unwanted sidelobes present in the spectrum to generate the RC filter spectrum repeated at multiples of the output sampling rate. The filters also lower the noise floor of the sampled signal outside the passband, and thereby improve the adjacent channel rejection of the signal.

Floating point and fixed point simulations for this baseline design have been completed. The main focus of the simulations is to test the modulator design for meeting the adjacent channel emissions specifications. The modulator architecture is able to meet the adjacent channel emissions specification with a root raised cosine filter of 48 taps operating at the rate of four samples per symbol. The DAC resolution is 10-bits. The selection of 44.96 MHz clock rate at the DAC results in a burst timing accuracy of 6.25% of the symbol period for Class B rate and 1.25% of the symbol period for Class A rate.

The digital upconversion module provides accurate digital frequency translation up to 58.5 kHz. The Doppler shift, expected to be less than 200 Hz, can also be accurately corrected at the digital upconverter. Floating point and fixed point simulation results for the digital modulator RC filter and the interpolation stages are given below. Simulations were carried out in floating point mode to investigate the length of the root raised cosine filter and the characteristics of the interpolating filters needed to meet the adjacent channel rejection specification.

Scaling of signals in the digital modulator is assigned such that the signal utilizes the maximum range allowed by the allocated word-size and should prevent clipping. The QPSK symbol stream introduces an overshoot of approximately 1.75-times over the height of a single root raised cosine pulse. The digital up-conversion introduces a maximum of \sqrt{2} scaling of the signal in each I and Q channels. These two factors have to be accounted when assigning the height of the root raised cosine pulse in the modulator. This can be explained further as follows. The I and Q channel input signal to the DAC is scaled such that the signal occupies 95% of the DAC input range. Taking account of the above two scaling factors, this will result in a root raised cosine filter impulse response that will be 95.0/(1.75×\sqrt{2})%=38.38% of the full scale of the DAC input.

The system implements a floating point RC filter operating at Class A symbol rate and a sampling rate of 44.96 MHz. The root raised cosine impulse response is scaled such that it occupies 38% of the DAC full scale. The floating point RC filter output is quantized to 8-bits and 10-bits. The root raised cosine filter operates at a sampling rate of 4-samples-per-symbol. The L5 filter interpolates the signal by a factor of five. The L4 filter (only used for the Class A symbol rate) interpolates the L5 filter output by a factor of four.

The DAC output power spectral density is then integrated over the signal band and the adjacent channel bandwidths to obtain the energies in these bands. For this set of simulations it is assumed that the adjacent channel energy is measured using a rectangular window spanning the adjacent channel bandwidth. Measuring the adjacent channel energy with a root raised cosine filter results in an improvement of approximately 3 dB over the results for a rectangular filter. The system uses the impulse response of the RC filter as the input to the interpolation stages. Only the data quantization effects of the DAC are included in these simulations. Table 3 illustrates the adjacent channel energy due to sample quantization effects, for RC filter tap lengths 32, 48 and 64 with 8-bit and 10-bit DAC resolutions.

The following are results of the floating point and fixed point simulations to assess the adjacent channel emissions resulting from various RC filter lengths and DAC resolutions.

TABLE 3
Adjacent Channel Energy - Floating point simulation results.

| RC Filter | DAC | | | |
|---|---|---|---|---|
| length | Resolution | AC - 1 | AC - 2 | AC - 3 |
| in # of | # of | Sample | Sample | Sample |
| symbols | bits | quantization | quantization | quantization |
| 8 | 8 | 37.68 dBc | 47.77 dBc | 53.49 dBc |
| 8 | 10 | 37.96 dBc | 52.88 dBc | 56.10 dBc |
| 12 | 8 | 41.30 dbc | 44.73 dBc | 53.15 dBc |
| 12 | 10 | 44.0 dBc | 64.09 dBc | 64.0 dBc |
| 16 | 8 | 41.3 | 44.74 | 53.15 |
| 16 | 10 | 46.84 | 60.27 | 61.92 |

The total adjacent channel energy is calculated in [1] as follows:

$$Total adjacent channel energy = Adjacent channel energy due to quantization \& windowing + Adjacent channel energy due to SSB rejection + Adjacent channel energy due to spectral regrowth at ODU$$

Integrated over a rectangular filter spanning the adjacent channel bandwidth, the energy contributions to the first adjacent channel from SSB rejection and spectral regrowth are given in [1] as follows: SSB rejection=41 dBc; spectral regrowth=40.5 dBc.

For the RC filter lengths and the DAC resolutions given in Table 3, the total adjacent channel energy in the first adjacent channel is indicated in Table 4.

TABLE 4
Total Energy in Adjacent Channel 1

| | | AC - 1 |
|---|---|---|
| RC Filter length | DAC Resolution | Adjacent channel |
| in # of symbols | # of bits | Energy |
| 8 | 8 | 34.69 dBc |
| 8 | 10 | 34.83 dBc |
| 12 | 8 | 36.15 dbc |
| 12 | 10 | 36.81 dBc |
| 16 | 8 | 36.15 dBc |
| 16 | 10 | 37.23 dBc |

The root raised cosine operates at a sampling rate of 4-samples-per-symbol. The L5 filter interpolates the signal by a factor of five. The L4 filter (only used for the Class A symbol rate) interpolates the L5 filter output by a factor of four. The RC filter and the interpolation stages are designed such that each stage uses 12-bit taps and 15-bit internal fixed point arithmetic. these simulations show the adjacent channel emission associated with the signal at the output of the interpolation stage and the effect of DAC resolution. The system uses the impulse response of the RC filter as the input to the interpolation stages. Only the data quantization effects of the DAC are included in these simulations. The filter taps are scaled such that the maximum fixed-point range.

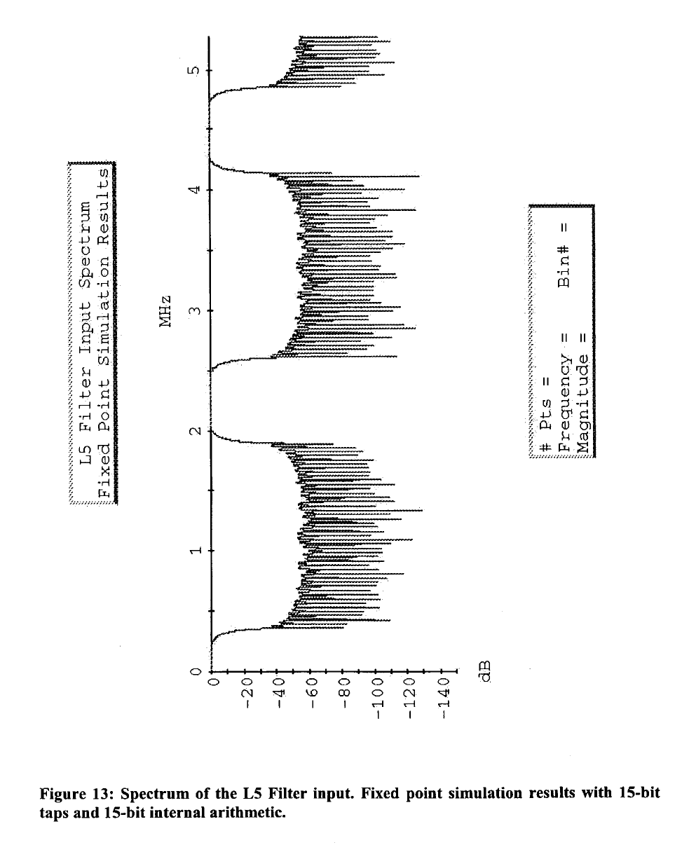

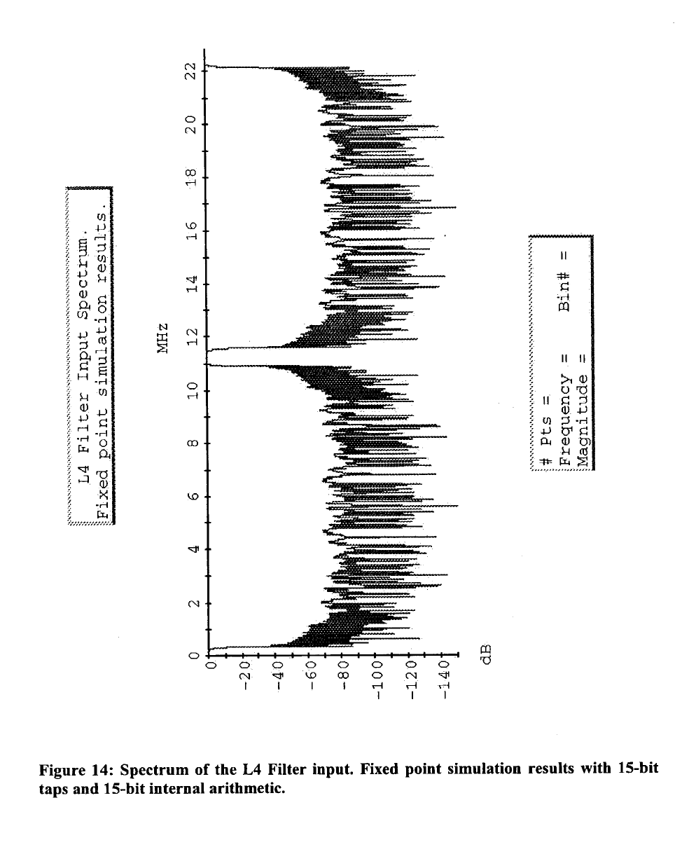

The L5 filter characteristics are interpolation factor=5; number of taps=25; passband-edge=^{0.6×f}^{_{sym}}; stopband edge=^{34×f}^{_{sym}}; passband attenuation=0.1 dB; stopband attenuation 60 dB. The L4 filter characteristics are interpolation factor=4; number of taps=16; passband-edge=^{f}^{_{sym}}; stopband edge=^{19.4×f}^{_{sym}}; passband attenuation=0.1 dB; stopband attenuation 60 dB. FIG. 13 shows the spectrum of the L5 filter input with the spectral components at ^{4×f}^{_{sym}}, ^{8×f}^{_{sym}}, ^{12×f}^{_{sym}} and ^{16×f}^{_{sym}} due to up-sampling of the RC filter output. The L5 filter removes these unwanted spectral components. FIG. 14 shows the spectrum of the input to the L4 filter. The L4 filter removes the spectral components at ^{20×f}^{_{sym}}, ^{40×f}^{_{sym}}, and ^{60×f}^{_{sym}} due to up-sampling of the L5 filter output.

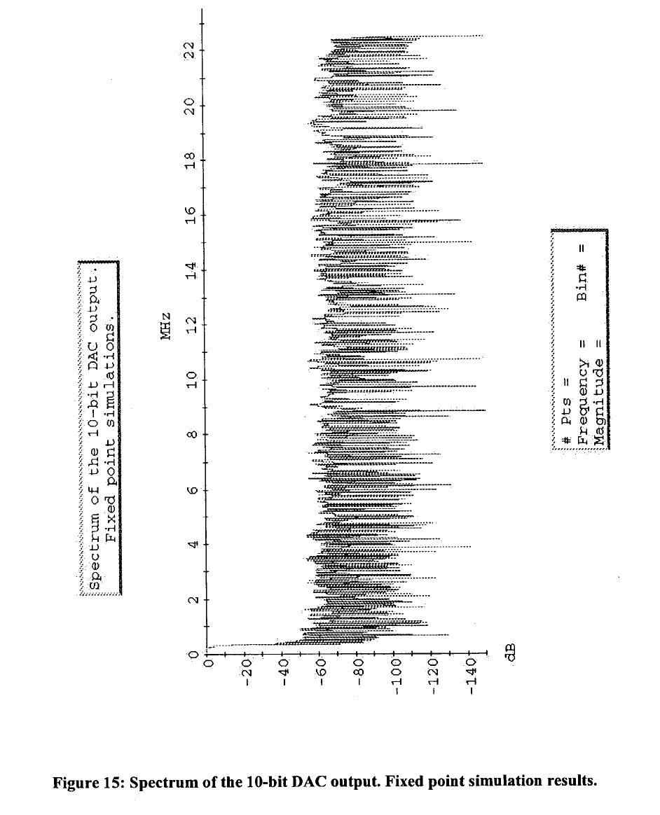

FIG. 15 shows the spectrum of the DAC output for a 10-bit resolution. Table 5 below shows the adjacent channel energy as a function of the RC filter length and the DAC resolution.

TABLE 5
Adjacent Channel Energy - Fixed point simulations

| | | | | | AC-1 |
|---|---|---|---|---|---|
| | | | | | Total Energy |
| RC filter | | | | | sample |
| length in | | AC-1 | AC-2 | AC-3 | quantization + |
| symbols | DAC | Energy due | Energy due | Energy due | SSB + |
| (at 4 × | Resolution | to sample | to sample | to sample | spectral |
| oversampling) | # of bits | quantization | quantization | quantization | regrowth |
| 8 | 8 | 37.79 dBc | 51.17 dBc | 50.85 | 34.75 |
| 8 | 10 | 38.17 dBc | 57.95 dBc | 69.33 | 34.93 |
| 12 | 8 | 41.34 dBc | 48.73 dBc | 48.18 | 36.16 |
| 12 | 10 | 43.91 dBc | 62.2 dBc | 65.65 | 36.79 |
| 16 | 8 | 41.48 dBc | 45.18 dBc | 47.55 | 36.2 |
| 16 | 10 | 46.88 dBc | 59.96 dBc | 63.64 | 37.23 |

Based on the floating and fixed point simulation results, it can be concluded that an RC filter length of 12-symbols (48-tap FIR filter) and a 10-bit DAC is required to meet the adjacent channel emission specification.

The following testbench was used to simulate the integrated system consisting of the root raised cosine filter, interpolation stage and the digital modulator. The system uses root raised cosine filter impulse response as the input to the chain. Root raised cosine filter impulse response is used as the input to the interpolation stage and the subsequent digital modulation stage. The simulation uses the same parameter settings as in Sections 6.1 and 6.2. The L4 filter output is frequency translated at the digital modulator. The frequency is adjusted by up to 58.5 kHz. In this simulation, we provide two translation frequencies. The NCO in the digital modulator is 32-bits wide and the sine and cosine look-up tables with 14-bit address space were used. For the 32-bit accumulator size, the frequency resolution of the NCO is 0.01 Hz. The frequency accuracy of the NCO also depends on the accuracy of the 44.96 MHz clock. Since the uplink clock extraction scheme is required to generate an extremely accurate reference clock for uplink frequency generation, the error introduced by the NCO reference clock will not be significant. It is possible to adjust the uplink frequency in the digital modulator by frequencies larger than the specified 2.5-58.5 kHz. Since the NCO clock is 44.96 MHz, it is possible to produce a wider range of frequencies out of the NCO if needed.

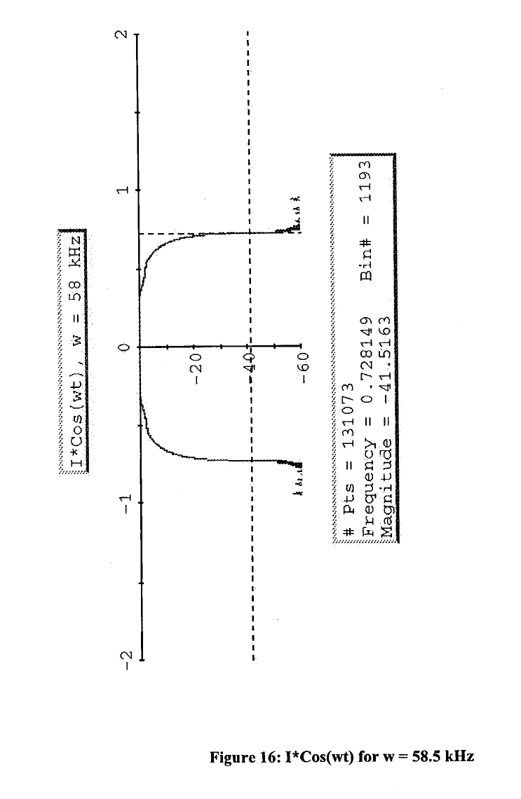

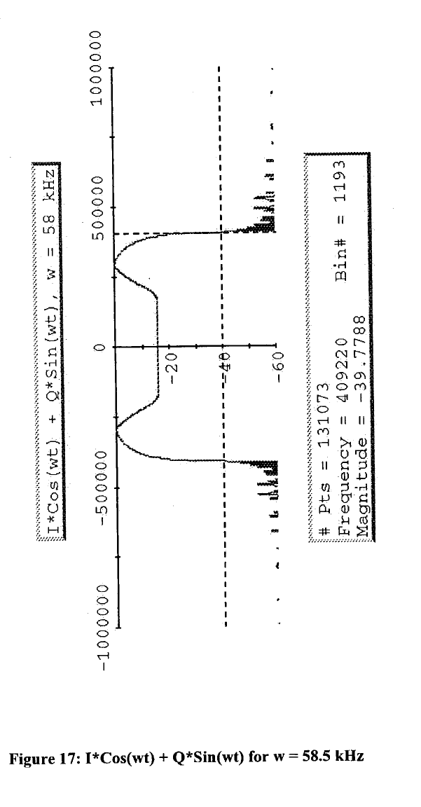

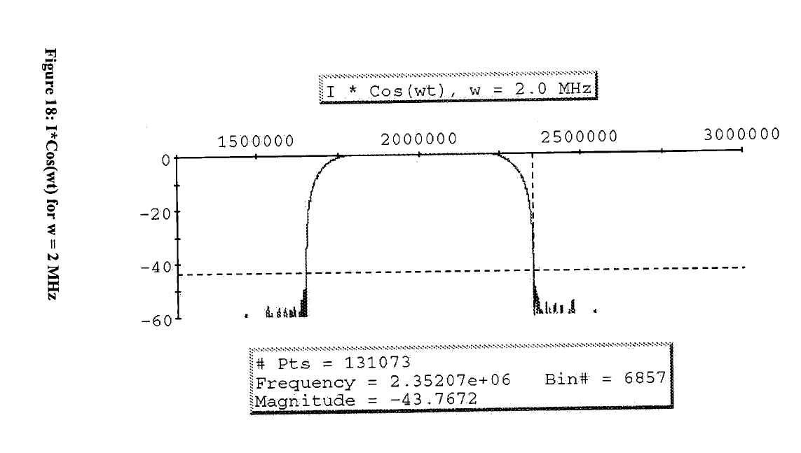

The spurious generated in the NCO due to truncation of the 32-bit accumulator to form the 14-bit LUT address will be in the worst case 84 dBc below the amplitude of the desired frequency. For the Class A symbol rate, the signal is frequency translated by 58.5 kHz and 2.0 MHz. For 58.5 kHz, the frequency shifted spectra overlap. The results show the spectrum of the digital modulator output before re-formatting to 8-bits. FIG. 16 and FIG. 17 show the spectrum of ^{I×Cos(ω t)} and ^{I×Cos(ω t)+Q×Sin(ω t)} respectively, for ^{ω=58 kHz}. FIGS. 18 and 19 show the spectrum of ^{I×Cos(ω t)} and ^{I×Cos(ω t)+Q×Sin(ω t)} respectively, for ^{ω=2 MHz}.

The current modulator supports two types of channel. They are class A and class B, each of which transmit at 0.562 Msps and 2.81 Msps. The current system modulation sample clock operate at the 44.96 MHz, which is 80 times of 0.562 MHz and 16 times of 2.81 MHz. So this design will interpolate the input symbol by 80 for class A mode and by 16 for class B in order to meet the system sample frequency.

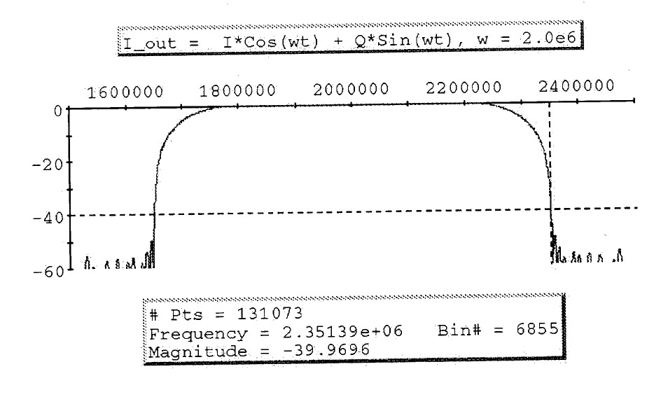

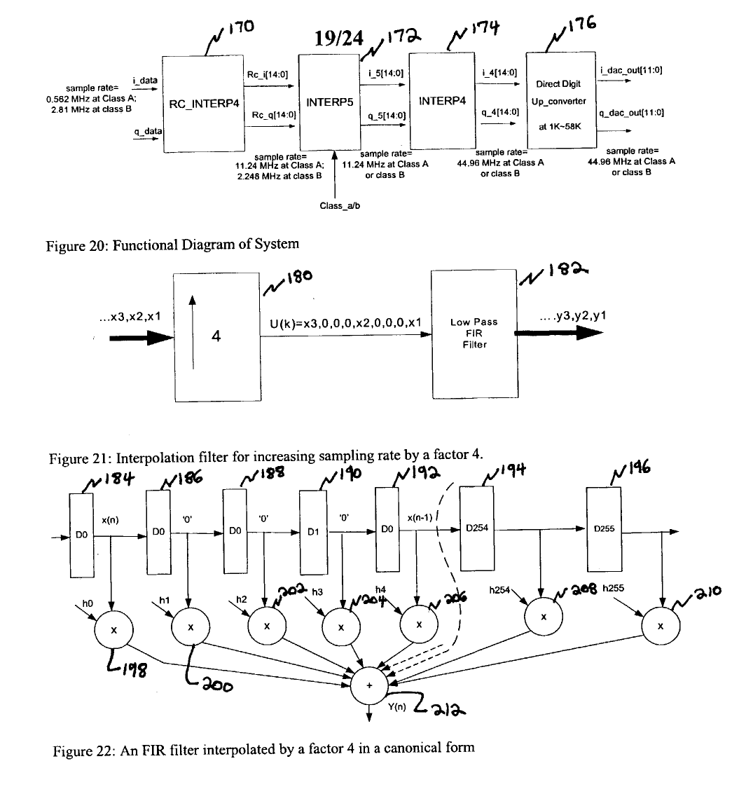

FIG. 20 illustrates a functional diagram of the overall system of the present invention. The first three blocks 170, 172 and 174 are FIR filters. The first block RC_INTERP4 170 is a root raised cosine filter, which receives the I and Q data from the QPSK mapper 100. RC_INTERP4 170 interpolates the data by a factor of 4 in the present invention, and transmits it output to INTERP5 172. If the current mode is class A, INTERP5 172 will interpolate the I and Q filtered data by 5, otherwise it will bypass the input data so that class B traffic is not interpolated. After this stage, both class A and class b data have the same data rate. The output of INTERP5 172 is transmitted to INTERP4 174. This interpolates the data by 4, so that the output data rate of INTERP4 174 is 44.96 MHz for the presently preferred embodiment. The output of INTERP4 174 is then transmitted to the digital upconversion block 176.

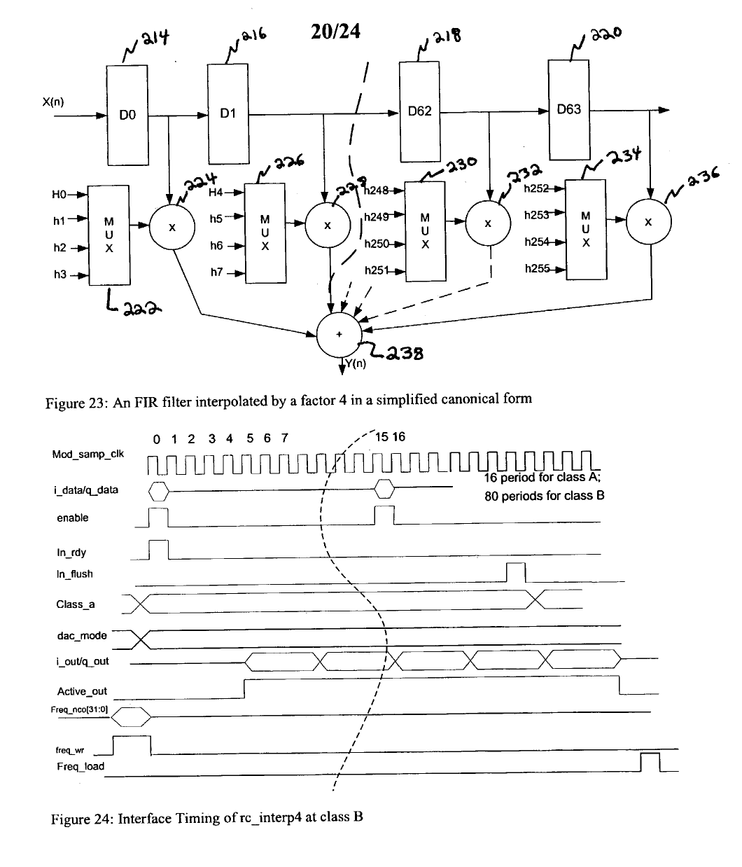

An interpolated FIR filter is shown in FIG. 21. If it is interpolated by 4, it will insert three ‘0’ between each original data. If the current low pass FIR filter with 256 taps is implemented in the canonical way, it is shown as FIG. 22. It use 256 pipeline registers to hold the data and 256 multiplier, and finally sum the 256 values to get the final output value Y(n). Because there are 3 consecutive ‘0’ between each X sample data. We can simplify this design by using multiplexer to select the correct filter coefficient at each different time clock tick, then the design can be reduced into FIG. 4 by using only 64 pipeline register to hold the input data, remove all of the inserted ‘0’ from the input data. It is shown in the FIG. 23. All of the three FIR filter will use the similar architecture to implement.

TABLE 6
Interface pins of RC_interp4

| | Input/ | Source/ | |
|---|---|---|---|
| Signal | Output | Destination | Description |
| demod_byte_clk | Input | Clk generator | Global Input: Clock input |
| | | | to the system |
| reset_n | 2 Input | Reset generator | Global Input: Active low |
| | | | asynchronous reset |
| I_data | Input | Parallel to serial | I data; ‘1’ mean value 1 |
| | | converter | ‘0’ mean value −1 |
| Q_data | Input | Parallel to serial | I data; ‘1’ mean value 1 |
| | | converter | ‘0’ mean value −1 |
| enable | Input | Parallel to serial | Data strobe to indicate |
| | | converter | the validity of data on |
| | | | the I_data and Q_data |
| | | | bus |
| In_rdy | Input | Parallel to serial | Single bit input indicates |
| | | converter | start of a frame. |
| In_flush | Input | Parallel to serial | Signal the end of input |
| | | converter | frame |
| Class_a | Input | Register Maker | ‘1’ uses class A channel; |
| | | Block | otherwise class B |
| | | | channel |
| load | output | INTERP5 | Data strobe to indicate |
| | | | the validity of data on |
| | | | the I_out[14:0] and |
| | | | Q_out[14:0] bus |
| active | Output | INTERP5 | It signify the input data |
| | | | Valid |
| I_out[14:0] | Output | INTERP5 | 15 bits output data for I |
| | | | channel |
| Q_out[14:0] | Output | INTERP5 | 15 bits output data for Q |
| | | | channel |
| Freq_load | Output | modulation | It trigger the NCO to |
| | | | generate new |
| | | | modulation frequency |

The RC_INTERP4 170 interface pin list for an exemplary embodiment is illustrated in Table 6. The current input date I_data and Q_data is a single bit. In a presently preferred embodiment, bit ‘1’ means a logically high value such as 1, while a bit ‘0’ value means a logically low value such as −1.

The interface timing is shown in the FIG. 24. The freq_load signal is a trigger signal , which trigger the NCO of modulation block to generate newly loaded NCO frequency, “freq_nco”. The RC_INTERP4 will compute the distance between the in_flush of last burst and in_rdy of current burst, then it generate the freq_load pulse in order to let the modulated frequency switching at the middle of the two output burst waveform. The I_out and q_out data will be produced one every four cycles in the class B channel mode or once per 20 cycles in the class A mode.

The RC_INTERP4 block has 256 filter taps and it will interpolated the data by 4. The current input data value is 1 or −1. So those the input data multiplied by those coefficients do not need to use multiplier to implement, instead, it uses multiplexer to select positive or negative coefficients value and sum the 64 values to get the final result shown in the FIG. 25.

TABLE 7
Interface pins of interp5

| | Input/ | Source/ | |
|---|---|---|---|
| Signal | Output | Destination | Description |
| demod_byte_clk | Input | Clk generator | Global Input: Clock input |
| | | | to the system |
| Reset_n | Input | Reset generator | Global Input: Active low |
| | | | asynchronous reset |
| I_data[14:0] | Input | RC_INTERP4 | I channel data (TBD) |
| Q_data[14:0] | Input | RC_INTERP4 | Q channel data (TBD) |
| Load | Input | RC_INTERP4 | Data strobe to indicate |
| | | | the validity of data on |
| | | | the I_data and Q_data |
| | | | bus |
| Class_a | Input | Register Maker | ‘1’ uses class A channel; |
| | | Block | otherwise class B |
| | | | channel |
| Active_in | Input | RC_INTERP4 | It signify the input data |
| | | | I_data and q_data valid |
| Load_out | output | INTERP4 | Data strobe to indicate |
| | | | the validity of data on |
| | | | the I_out[14:0] and |
| | | | Q_out[14:0] bus |
| Active_out | Output | INTERP4 | It signify the output data |
| | | | I_out and q_out valid |
| I_out[14:0] | Output | INTERP4 | 15 bits output data for I |
| | | | channel (TBD) |
| Q_out[14:0] | Output | INTERP4 | 15 bits output data for Q |
| | | | channel (TBD) |

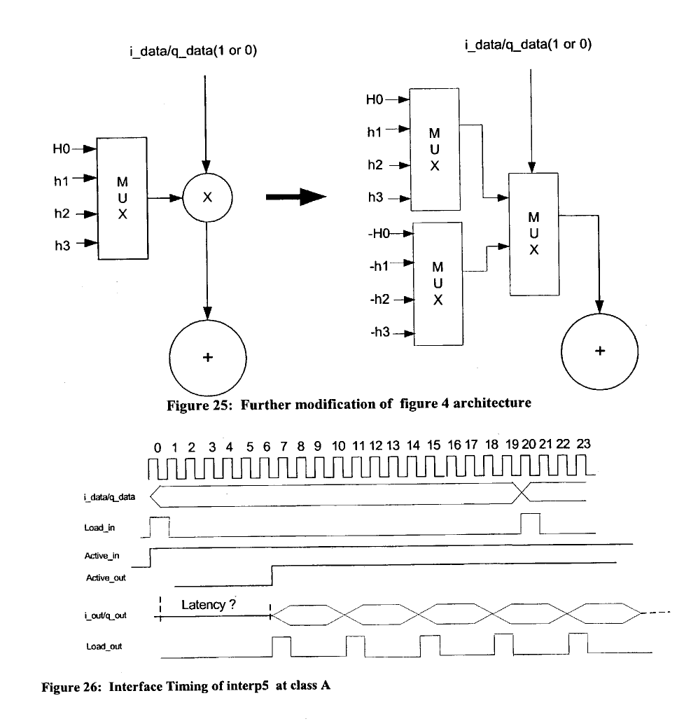

Table 7 shows the interface pins of “interp5” module. Both the input data I_data[14:0], q_data[14:0] and I_out[14:0], q_out[14:0] use 15 bits data bus. Once the external IF DAC is decided, It will be defined. The Interp5 block interpolates the input data by 5 in the channel mode at class A. It generates 5 output data per input sample I_data and q_data shown in the FIG. 26. When it work in the class B, it only pass the input data I_data and q_data into the output The output data rate will be 11.24 MHz for class A or B.

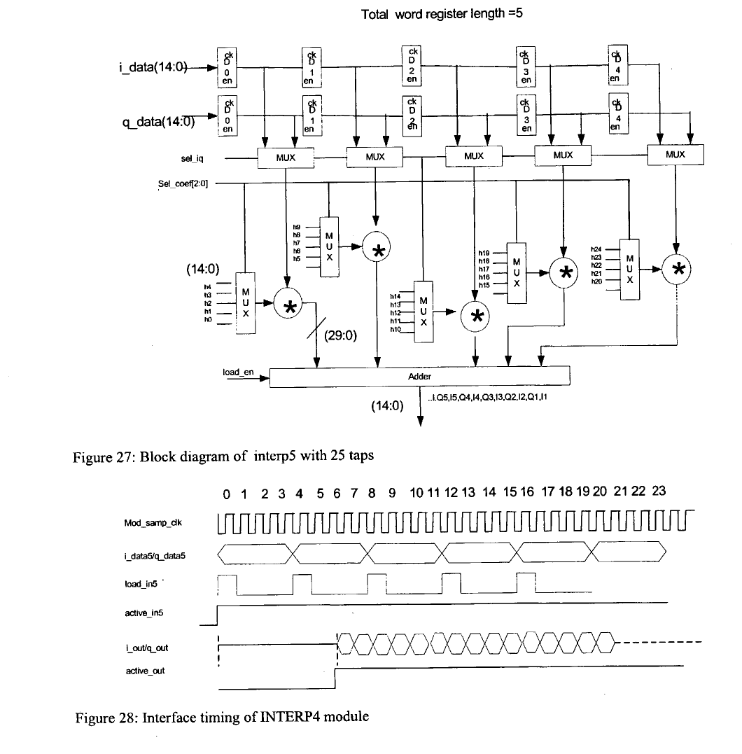

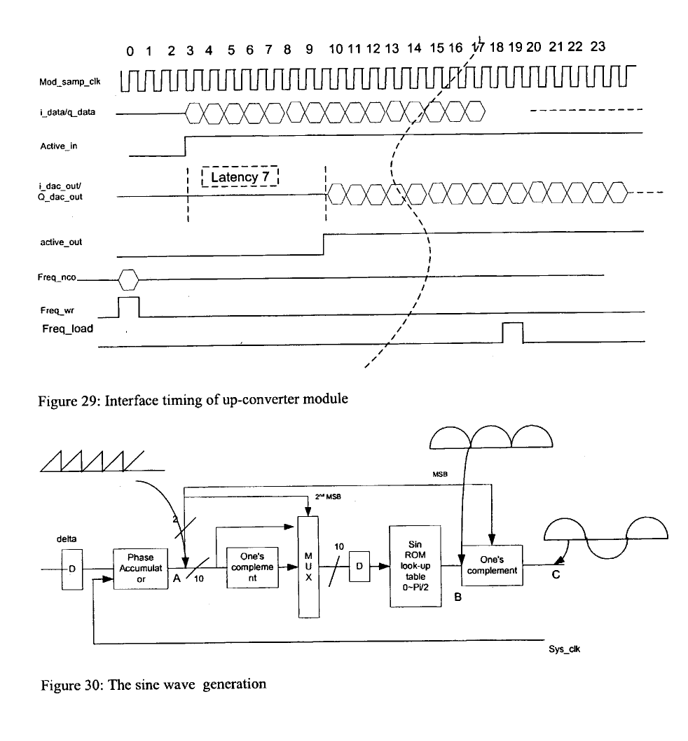

The Interp5 has 25 filter taps and in will interpolate the input data by 5 in the class mode A. The design is implemented shown in the FIG. 27. It add some control signal “sel_coef[2:0]” to select the coefficient and it also use sel_iq data to select the I_data or Q_data alternatively. From the FIG. 26 timing diagram, One sample data per 20 cycles, the I_data and q_data can be processed in a shared hardware.

TABLE 8
Interface pins of interp4

| | Input/ | Source/ | |
|---|---|---|---|
| Signal | Output | Destination | Description |
| demod_byte_clk | Input | Clk generator | Global Input: Clock input |
| | | | to the system |
| Reset_n | Input | Reset generator | Global Input: Active low |
| | | | asynchronous reset |
| I_data5[14:0] | Input | INTERP5 | I data |
| Q_data5[14:0] | Input | INTERP5 | Q data |
| Load_in5 | Input | INTERP5 | Data strobe to indicate |
| | | | the validity of data on |
| | | | the I_data and Q_data |
| | | | bus |
| Active_in5 | Input | INTERP5 | It signify the input data |
| | | | I_data5 and q_data valid |
| Active_out | Output | Modulation | It signify the input data |
| | | | I_out and q_out valid |
| I_out[14:0] | Output | Modulaation | 15 bits output data for I |
| | | | channel |
| Q_out[14:0] | Output | Modulation | 15 bits output data for Q |
| | | | channel |

The interface pin of interp4 is shown in the Table 8. The timing diagram is show in the FIG. 28. The input data rate is sampled once per four clocks. After the data is interpolated by 4, the output data rate is 44.96 MHz.

The FIR filter has 16 taps and it interpolates the input data by 4. The design is the same as INTERP5, except that the hardware multiplier and adder can not be shared between I and Q channels, so each I_data5 or q_data5 input data use different multiplier and adder.

TABLE 9
Interface pins of modulation

| | Input/ | Source/ | |
|---|---|---|---|
| Signal | Output | Destination | Description |
| demod_byte_clk | Input | Clk generator | Global Input: Clock input |
| | | | to the system |
| reset_n | Input | Reset generator | Global Input: Active low |
| | | | asynchronous reset |
| I_data | Input | Interp4 | Channel I data |
| Q_data | Input | Interp4 | Channel q data |
| Active_in | input | lnterp4 | It signify the input data |
| | | | valid |
| Data_mode | Input | Register Maker | ‘1’ use unsigned mode |
| | | Block | for I_dac_out and |
| | | | q_dac_out. ‘0’ use two's |
| | | | complement mode. |
| Freq_nco[31:0] | input | Event Handler | Set NCO frequency |
| Trigger_pulse | input | Event Handler | Qualify Freq_nco |
| Freq_load | input | Rc_interp5 | It trigger the NCO to |
| | | | generate new |
| | | | modulation frequency |
| I_dac_out | Output | External IF | 12 bits output data for I |
| | | modulator | channel. (TBD) |
| Q_dac_out | Output | External IF | 12 bits output data for Q |
| | | modulator | channel. (TBD) |

The output pin I_dac_out and q_dac_out will be connected to external IF chip. Now the external DAC will use 10 bits or 12 bits. It includes two parts, one part is a numerically controlled oscillator to generate the required frequency. Another part is an up-convert the input data by the NCO generated frequency.

FIG. 11 indicates the direct digital synthesis block of digital modulator. It counts up, adding the frequency parameter on every reference clock rising edge. This ramp value from the accumulator acc[31:21] in A selects sin and cos output from the 2048-element look-up table that shapes the output into a 0˜2π sine and cosine waves. In order to save the lookup table memory size, it only use acc[29:21] with 9 bits to be used for select 512-element look-table with 0 to π/2. The sine and cosine waves are stored in the signed magnitude form. The acc[31:30] with one of the values 00, 01, 10 and 11 represent sin wave 0˜π/2, π/2˜π, π˜3 π/2, or 3π/2˜2π each. The second most acc bit is used to complement the input address in order to get correct absolute value from look-up table. When the second msb is ‘1’, the input address must be complemented in order to get sin wave in point B. An example is as follows. The acc=“01010000000” corresponds to sin(5π/8). If the address is not modified, the output will get sin(π/8) other than sin(5π/8). In order to get correct output from the look-up table for sin(5π/8), the input address ,acc[29:21]=“010000000”, must be complemented to get “101111111”, the output value from look-up table is sin(3π/8). The absolute value of sin(5π/8) and sin(3π/8) are same. When the acc[31:21]=“10100000000”, which is sin(5π/4). In order to get correct negative output value, the output value must be complemented to get negative value.

Fₛₜₑₚ=f_{ref}/(2³^{₂})=44.96 Mhz/(2³^{₂})=0.01046806574 Hz/LSB

The current frequency is a 32 bits register delta. The generated frequency is

NCO_{freq}=FₛₜₑₚX(frequency)

The second part is up-convert the input I_data and q_data to the defined frequency, which is

I_dac_out=I_data X Cos(w₁t)+Q_data X Sin(w₁t) and Q_dac_out=Q_data X Cos(w₁t)−I_data X Sin(w₁t)

TABLE 10
Interface pins of top system block

| | Input/ | Source/ | |
|---|---|---|---|
| Signal | Output | Destination | Description |
| demod_byte_{—} | Input | Clk generator | Global Input: Clock input |
| clk | | | to the system |
| reset_n | Input | Reset generator | Global Input: Active low |
| | | | asynchronous reset |
| I_data | Input | Parallel to serial | I data; ‘1’ mean value 1 |
| | | converter | ‘0’ mean value −1 |
| Q_data | Input | Parallel to serial | I data; ‘1’ mean value 1 |
| | | converter | ‘0’ mean value −1 |
| Enable | Input | Parallel to serial | Data strobe to indicate |
| | | converter | the validity of data on |
| | | | the I_data and Q_data |
| | | | bus |
| In_rdy | Input | Parallel to serial | Single bit input indicates |
| | | converter | start of a frame. |
| In_flush | Input | Parallel to serial | Signal the end of input |
| | | converter | frame |
| Class_a | Input | Register Maker | ‘1’ uses class A channel; |
| | | Block | otherwise class B |
| | | | channel |
| Dac_mode | Input | Register Maker | ‘1’ use unsigned mode |
| | | Block | for I_dac_out and |
| | | | q_dac_out. ‘0’ use two's |
| | | | complement mode. |
| Freq_nco | input | Event Handler | Set NCO frequency |
| [31:0] | | | |
| Trigger_pulse | input | Event Handler | Qualify Freq_nco |
| I_dac_out | Output | External IF chip | 12 bits output data for I |
| [11:0] | | | channel (TBD) |
| Q_dac_out | Output | External IF chip | 12 bits output data for Q |
| [11:0] | | | channel (TBD) |

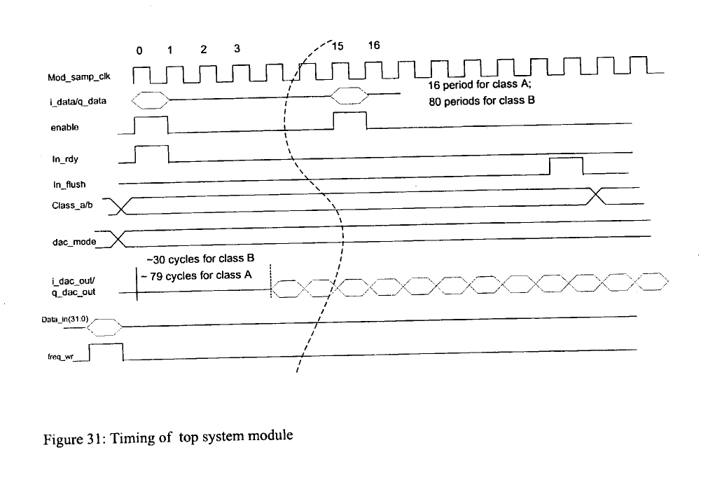

Table 10 show the interface pin list of the top system block. I_dac_out and q_dac_out data bus width is to be defined. The FIG. 31 shows the interface timing diagram. The class_a/b mode signal should be stable before the last burst data come out. If the in_rdy does not signal after last one at the multiples times of 16 in class B or 80 in the class B, the data will be latched in the input. It is processed until the delay time is aligned at the multiple times of 16 or 80.

TABLE 11
Register Map

| Address | Description | R/W |
|---|---|---|
| TBD | DAC output mode | R/W |
| | default value = 1′b0, | |
| | ‘0’ :two's complement mode;‘1’: Unsigned output | |
| TBD | Burst Rate | R/W |
| | default value = 1′b0; ‘1’ class A; ‘0’ class B access | |
| | macro = | |

Table 11 show the registers are set in the system initialization

The modulator architecture uses the availability of a high system clock of 44.96 MHz and the two fixed data transmission rates to implement an efficient hardware structure that is of very low complexity. The root raised cosine filter is implemented without hardware multipliers by using multiplexing to select the corresponding output values for each coefficient- input product. The finite number of levels in the QPSK input data symbol is used as the select input for each multiplexer. This technique can be easily applied to 16-QAM, and 64-QAM modulation schemes. The interpolating filters use multiplexing techniques to select each efficient alternatively. This reduces the size of the data shift register needed to implement the FIR filter.

A key feature of the scheme is that the length of the raised cosine filter and the interpolating filters can be made programmable without incurring added hardware complexity. This provides flexibility in designing the modulator to meet the adjacent channel emission and root raised cosine filter spectral mask specifications. The digital up-conversion provides means of Doppler pre-corrections and frequency adjustments for channelization etc. The digital modulator can also be used to accurately up-convert the baseband signal by up to 10 MHz.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A digital demodulator for a satellite communication system, comprising:
a QPSK mapper for receiving an input analog signal and mapping input signal to I and Q data streams, respectively;
a pair of root raised cosine filters for filtering the I and Q data streams, respectively;
a corresponding pair of interpolators for interpolating the filtered data streams;
a digital up-converter, receiving sine and cosine signals from a numerically controlled oscillator, for up-converting the interpolated signals; and
a pair of digital to analog converters for converting the up-converted digital signals to analog signals.
